(19) United States
(12) Patent Application Publication
(10) Pub. No.: US 2015/0260919 A1
(43) Pub. Date: Sep. 17, 2015

(54) WAVELENGTH-DIVISION MULTIPLEXING AND DEMULTIPLEXING DEVICE

(71) Applicant: Suzhou InnoLight Technology Corporation, Suzhou (CN)

(72) Inventor: Yuzhou SUN, Suzhou (CN)

(73) Assignee: Suzhou InnoLight Technology Corporation

(21) Appl. No.: 14/656,745

(22) Filed: Mar. 13, 2015

(30) Foreign Application Priority Data
Mar. 17, 2014 (CN) 201420118695.9

(51) Int. Cl. G02B 6/293

(52) U.S. Cl. CPC G02B 6/2938; G02B 6/29389

(57) ABSTRACT

A wavelength-division multiplexing and demultiplexing device is disclosed. The device comprises: a transparent substrate, disposed in an optical path of at least one incident beam; a first total internal reflection film on an upper surface of said transparent substrate; multiple optical filters on a lower surface of said transparent substrate, with a predetermined spacing between adjacent optical filters; and a second total internal reflection film at least on an exposed portion of the lower surface of said transparent substrate. A thickness of said transparent substrate is such that an incident beam is reflected at least three times within said transparent substrate when the beam is transmitted from a location of one optical filter to a location of an adjacent optical filter.

### CROSS-REFERENCE TO RELATED APPLICATION

This application claims the benefit of priority to Chinese Application No. 201420118695.9, filed Mar. 17, 2014.

### TECHNICAL FIELD

This disclosure relates to the technical field of optical transceiver modules in telecommunications and, in particular, a wavelength-division multiplexing and demultiplexing device.

### BACKGROUND

With the rapid increase in human demand for telecommunication bandwidth, existing telecommunication systems are faced with two major challenges: capacity and energy consumption. In order to provide greater bandwidth in a smaller space consuming less energy, research and development in concurrent optical modules has been growing. However, in existing technologies, the package size for these wavelength-division multiplexing and demultiplexing devices is too large.

### SUMMARY

This disclosure provides a wavelength-division multiplexing and demultiplexing device to overcome the deficiencies in existing technologies. The device achieves reduction in package size through multiple reflections on the optical path between channels.

According to an embodiment, a wavelength-division multiplexing and demultiplexing device is disclosed. The device includes a transparent substrate, disposed in an optical path of at least one incident beam; a first total internalreflection film on an upper surface of said transparent substrate; multiple optical filters on a lower surface of said transparent substrate, with a predetermined spacing between adjacent optical filters; and a second total internalreflection film at least on an exposed portion of the lower surface of said transparent substrate. A thickness of said transparent substrate is such that an incident beam is reflected at least three times within said transparent substrate when the beam is transmitted from a location of one optical filter to a location of an adjacent optical filter.

According to a further embodiment, said second total internalreflection film covers the lower surface of said transparent substrate.

According to a further embodiment, the thickness of said transparent substrate is greater than or equal to A/(2*tan α), where A is a light spot diameter of the incident beam and α is an angle between the incident beam and a normal to the upper and lower surfaces of the transparent substrate.

According to a further embodiment, the number of times that said incident beam is reflected by the lower surface of said transparent substrate between the adjacent optical filters is fewer than or equal to L/A, where L is a distance between center points of adjacent optical filters and A is the light spot diameter of the incident beam.

According to a further embodiment, said optical filters are disposed in a one-to-one corresponding relationship with said incident beams.

According to a further embodiment, a wavelength-division multiplexing and demultiplexing device is disclosed. The device includes a transparent substrate, disposed in an optical path of at least one incident beam; a first total reflection film on an upper surface of said transparent substrate; transmission films on a lower surface of said transparent substrate, adjacent ones of the transmission files having a predetermined spacing therebetween; and a second total reflection film at least on an exposed portion of the lower surface of said transparent substrate. A thickness of said transparent substrate is such that an incident beam is reflected at least three times within said transparent substrate when the beam is transmitted from a location of one transmission film to a location of an adjacent transmission film.

According to a further embodiment, said second total internalreflection film covers the lower surface of said transparent substrate.

According to a further embodiment, a thickness of said transparent substrate is greater than or equal to A/(2*tan α), where A is a light spot diameter of the incident beam and α is an angle between the incident beam and a normal to the upper and lower surfaces of the transparent substrate.

According to a further embodiment, the number of times that said incident beam is reflected by the lower surface of said transparent substrate between the adjacent transmission films is fewer than or equal to L/A, where L is a distance between the center points of adjacent transmission films and A is the light spot diameter of the incident beam.

According to a further embodiment, said optical filters are disposed in a one-to-one corresponding relationship with said incident beams.

### BRIEF DESCRIPTION OF THE DRAWINGS

FIG. 1 is a schematic diagram showing an embodiment of the wavelength-division multiplexing and demultiplexing device, according to an embodiment;

FIG. 2 is a schematic diagram showing another embodiment of the wavelength-division multiplexing and demultiplexing device, according to an embodiment; and

FIG. 3 is a schematic diagram showing yet another embodiment of the wavelength-division multiplexing and demultiplexing device, according to an embodiment.

### DETAILED DESCRIPTION OF EXEMPLARY EMBODIMENTS

The text below provides detailed descriptions of embodiments of the disclosure as shown in the accompanying drawings. However, these embodiments do not limit the scope of the disclosure. Any changes made to the structure, method, or function by persons of ordinary skill in the art based on the embodiments are within the scope of this disclosure.

The wavelength division multiplexing and demultiplexing device disclosed herein provides an improvement, wherein by adjusting the thickness of the transparent substrate and by utilizing multiple reflections on the optical path, the package size of the substrate for the multiplexing and demultiplexing device is reduced. This reduction contributes to a reduction in package size for the device and an expansion of its scope of application.

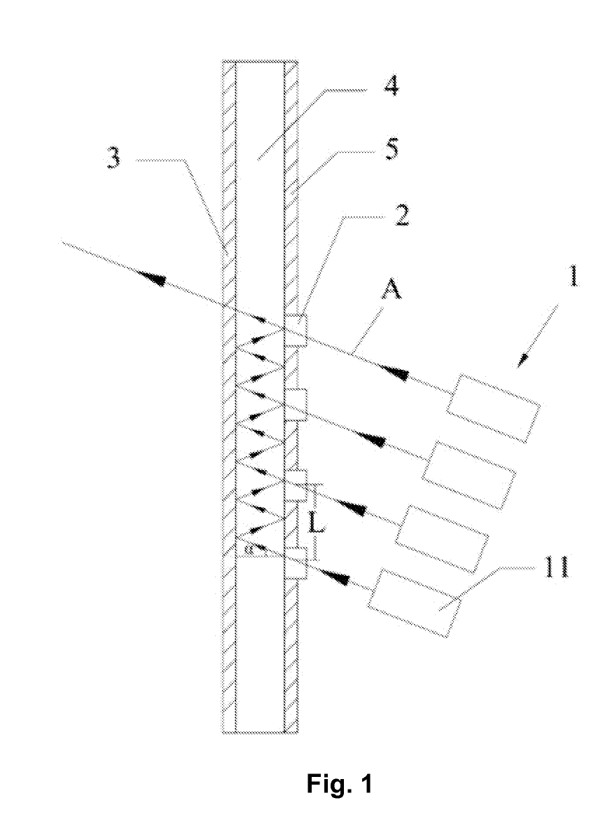

FIG. 1 is a schematic diagram showing an embodiment of a wavelength division multiplexing and demultiplexing device consistent with embodiments of the disclosure. The wavelength-division multiplexing and demultiplexing device comprises sequentially placed optical filters 2, a transparent substrate 4, and a receiving end (not shown in the drawing).

Specifically, a light source 1 is set on one side of said wavelength-division multiplexing and demultiplexing device, and said light source 1 may provide at least one incident beam. Preferably, the light source 1 comprises multiple laser devices 11, which are set along a single straight line at equal intervals to provide multiple collimated incident beams. The multiple collimated incident beams are set in a one-to-one corresponding relationship with the multiple optical filters 2.

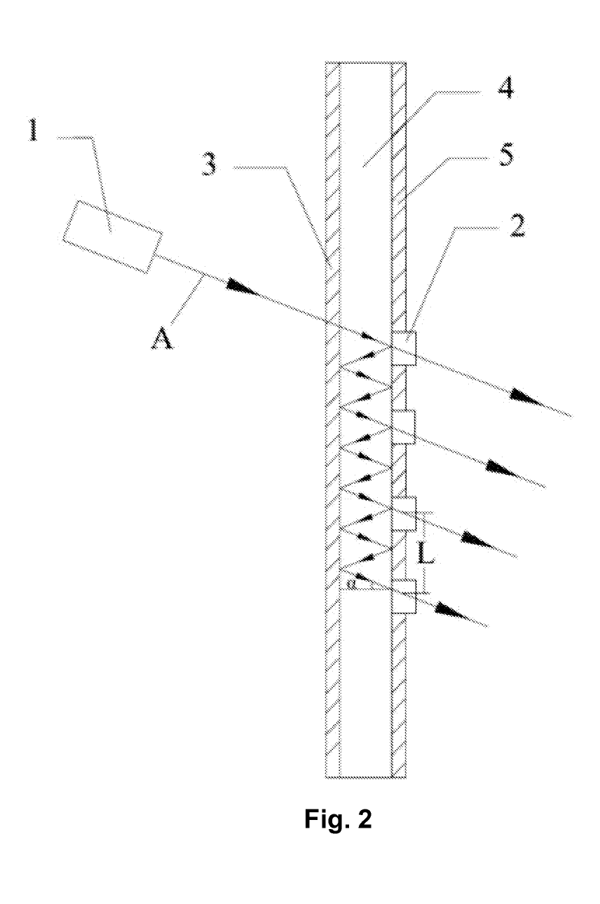

In another embodiment, as shown in FIG. 2, the light source 1 may also be set in a location at the receiving end. With a single laser device 11 in the light source 1, multiple collimated exiting beams can be formed through the transparent substrate and optical filters 2.

The aforementioned transparent substrate 4 is located on the optical path of the incident beam. The multiple optical filters 2 are set on the lower surface of said transparent substrate 4 with fixed intervals between adjacent optical filters 2. The optical filters 2 are set corresponding to the exiting beams from the lower surface of the transparent substrate 4 formed from the incident beam through the transparent substrate. In particular, a first total internal reflection film 3 is applied to the upper surface of said transparent substrate 4, and a second total internal reflection film 5 is applied to the lower surface opposite to the upper surface.

Specifically, said second total internal reflection film 5 is set at least on uncovered/exposed portions of the lower surface of the transparent substrate 4, i.e., areas where the transparent substrate 4 are not covered by the optical filters 2. In yet another embodiment, second total internal reflection film 5 covers the lower surface of the transparent substrate 4, and then the optical filters 2 are placed on the second total internal reflection film 5. The reflective surface of the first total internal reflection film 3 faces that of the second total internal reflection film 5 in order to allow multiple reflections of the incident beam in the transparent substrate 4.

In particular, the thickness of the transparent substrate 4 is set in such a way that any incident beam is reflected at least three times within the transparent substrate when the beam is transmitted from the location of one optical filter 2 to that of an adjacent optical filter 2. This can be achieved by changing the thickness of the transparent substrate 4. Specifically, the size of the wavelength-division multiplexing and demultiplexing device can be further reduced by reducing the thickness of the transparent substrate 4.

According to an embodiment, the package size of said transparent substrate 4 can be set in a controlled manner. Specifically, the thickness of said transparent substrate 4 is greater than or equal to A/(2*tan α, where A is the light spot diameter of the incident beam and α is the angle between the incident beam and the normal to the upper and lower surfaces of the transparent substrate as shown in FIG. 1.

The number of times that said incident beam is reflected by the lower surface of the transparent substrate between adjacent optical filters 2 is fewer than or equal to L/A, where L is the distance between adjacent incident beams on the optical filters 2 and A is the light spot diameter of the incident beam. Preferably, L is measured from the center points of optical filters 2 in order to minimize error and improve the accuracy of the calculation.

Preferably, the transparent substrate 4 is a glass substrate. Of course, in other embodiments, other transparent substrate 4 may be used. In an embodiment, the optical filters 2 are bandpass optical filters.

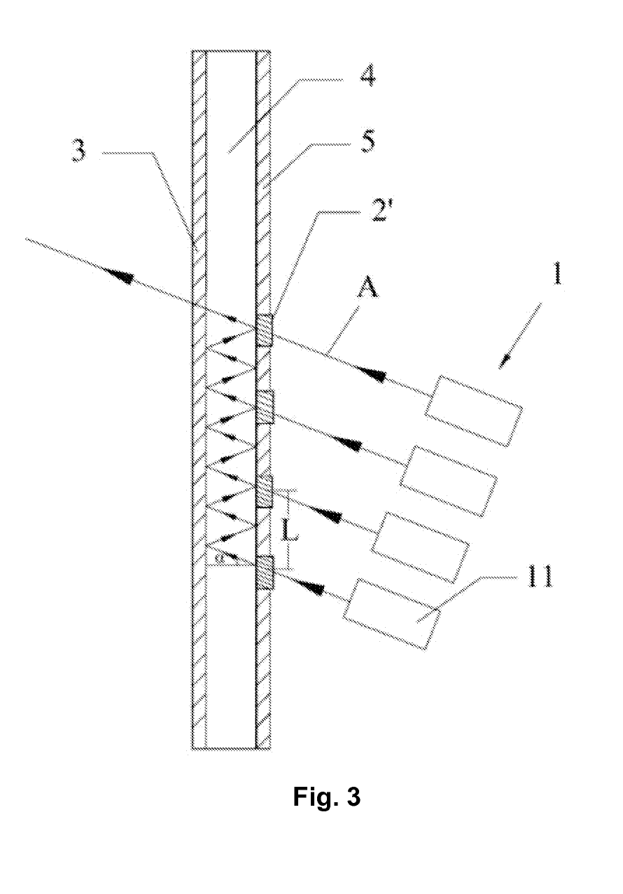

Please refer to FIG. 3, which is a schematic diagram showing yet another embodiment of the wavelength-division multiplexing and demultiplexing device, the wavelength-division multiplexing and demultiplexing device comprises sequentially placed light sources 1, transmission films 2′, a transparent substrate 4, and a receiving end, wherein the optical filters 2 in FIGS. 1 and 2 are replaced by transmission films 2′, which enables selective removal of undesired wavelengths as needed. Specifically, said transmission films 2′ are set in a way to allow the transmission of light of certain wavelengths, while light of other wavelengths is reflected back or rejected by said transmission films 2′.

The disclosed wavelength-division multiplexing and demultiplexing device uses the relationship between the light spot diameter of the incident beam and the angle between the incident beam and the normal of the transparent substrate 4, as well as the relationship between the number of reflections, the distance between the incident beams on adjacent optical filters 2 or transmission films 2′, and the diameter of the incident beams. In this manner, by having multiple reflections on the optical path, the package size of the substrate for the multiplexing and demultiplexing device is reduced, which contributes to a reduction in package size for the device and an expansion of its scope of application.

The descriptions above are only intended to provide specific descriptions of feasible embodiments. The detailed descriptions are not to be construed as limiting the scope of protection for the disclosure. All equivalent embodiments or changes that are not detached from the techniques disclosed here should fall under the scope of protection of the disclosure.

What is claimed is:

1. A wavelength-division multiplexing and demultiplexing device, comprising:
a transparent substrate, disposed in an optical path of at least one incident beam;
a first total internal reflection film on an upper surface of said transparent substrate;
a plurality of optical filters on a lower surface of said transparent substrate, with a predetermined spacing between adjacent optical filters; and
a second total internal reflection film at least on an exposed portion of the lower surface of said transparent substrate,
wherein a thickness of said transparent substrate is such that an incident beam is reflected at least three times within said transparent substrate when the beam is transmitted from a location of one optical filter to a location of an adjacent optical filter.

2. The wavelength-division multiplexing and demultiplexing device according to claim 1, wherein said second total internal reflection film covers the lower surface of said transparent substrate.

3. The wavelength-division multiplexing and demultiplexing device according to claim 1, wherein the thickness of said transparent substrate is greater than or equal to A/(2*tan α), where A is a light spot diameter of the incident beam and α is an angle between the incident beam and a normal to the upper and lower surfaces of the transparent substrate.

4. The wavelength-division multiplexing and demultiplexing device according to claim 3, wherein the number of times that said incident beam is reflected by the lower surface of said transparent substrate between the adjacent optical filters is fewer than or equal to L/A, where L is a distance between center points of adjacent optical filters and A is the light spot diameter of the incident beam.

5. The wavelength-division multiplexing and demultiplexing device according to claim 1, wherein said optical filters are disposed in a one-to-one corresponding relationship with said incident beams.

6. A wavelength-division multiplexing and demultiplexing device, comprising:
a transparent substrate, disposed in an optical path of at least one incident beam;
a first total internal reflection film on an upper surface of said transparent substrate;
transmission films on a lower surface of said transparent substrate, adjacent ones of the transmission films having a predetermined spacing therebetween; and
a second total internal reflection film at least on an exposed portion of the lower surface of said transparent substrate,
wherein a thickness of said transparent substrate is such that an incident beam is reflected at least three times within said transparent substrate when the beam is transmitted from a location of one transmission film to a location of an adjacent transmission film.

7. The wavelength-division multiplexing and demultiplexing device according to claim 6, wherein said second total internalreflection film covers the lower surface of said transparent substrate.

8. The wavelength-division multiplexing and demultiplexing device according to claim 6, wherein a thickness of said transparent substrate is greater than or equal to A/(2*tan α), where A is a light spot diameter of the incident beam and α is an angle between the incident beam and a normal to the upper and lower surfaces of the transparent substrate.

9. The wavelength-division multiplexing and demultiplexing device according to claim 8, wherein the number of times that said incident beam is reflected by the lower surface of said transparent substrate between the adjacent transmission films is fewer than or equal to L/A, where L is a distance between the center points of adjacent transmission films and A is the light spot diameter of the incident beam.

10. The wavelength-division multiplexing and demultiplexing device according to claim 6, wherein said optical filters are disposed in a one-to-one corresponding relationship with said incident beams.
